(19) United States
(12) Patent Application Publication
(10) Pub. No.: US 2008/0194778 A1
(43) Pub. Date: Aug. 14, 2008

(54) Process For Preparing Precipitation Polymers By Spray Polymerization

(75) Inventors: Dennis Losch, Altrip (DE); Christian Hubert Weidl, Mannheim (DE); Volker Seidl, Mannheim (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BASF AKTIENGESELLSCHAFT, Ludwigshafen (DE)

(21) Appl. No.: 11/911,232

(22) PCT Filed: Apr. 24, 2006
(86) PCT No.: PCT/EP2006/061785

§ 371 Date: Oct. 11, 2007

(30) Foreign Application Priority Data
Apr. 25, 2005 (DE) 102005019398.6

(51) Int. Cl. C08F 2/06

(52) U.S. Cl. 526/67; 526/72; 526/258; 526/303.1; 526/310; 526/89

(57) ABSTRACT

A process for preparing precipitation polymers by spray polymerization of a monomer solution comprising at least one ethylenically unsaturated monomer and at least one solvent, the monomer being soluble in the solvent, and the polymer obtained by the polymerization of the monomer being insoluble in the solvent, and also the use of the polymers for thickening liquids.

The present invention relates to a process for preparing precipitation polymers by spray polymerization of a monomer solution comprising at least one ethylenically unsaturated monomer and at least one solvent, the monomer being soluble in the solvent, and the polymer being insoluble in the solvent, and also to the use of the polymers for thickening liquids.

Further embodiments of the present invention can be taken from the claims, the description and the examples. It is evident that the features of the inventive subject-matter which have been specified above and are yet to be illustrated below can be used not only in the combination specified in each case, but also in other combinations, without leaving the scope of the invention.

EP-A-0 328 725 and EP-A-0 814 101 describe the preparation of thickeners by precipitation polymerization of acrylic acid.

U.S. Pat. No. 3,644,305 discloses a spray polymerization process with which low molecular weight polymers can be prepared. The polymerization is carried out at elevated pressure.

According to the patent application WO-A-96/40427, the spray polymerization is carried out in such a way that monomer solutions are sprayed into a heated, substantially static atmosphere.

It was an object of the present invention to provide an improved process for preparing polymeric thickeners.

The polymeric thickeners should consist of small primary particles, preferably smaller than 1 μm, so that the thickened products do not have a perceptibly grainy structure. Such polymeric thickeners are regarded as being structureless and are preferred, for example, in the cosmetics industry.

Furthermore, the polymeric thickeners should not comprise any surfactants, as is the case, for example, for thickeners prepared by emulsion polymerization. The surfactants can lead to undesired opacity when they are employed.

The object was achieved by a process for spray polymerization of a monomer solution comprising

a) at least one ethylenically unsaturated monomer,

b) at least one solvent,

c) if appropriate at least one crosslinker and

d) if appropriate at least one initiator,

the monomer a) being soluble in the solvent b), and the polymer obtained by polymerization of the monomer a) being insoluble in the solvent b).

The solubility of the monomer a) in the solvent b) at 23° C. is preferably at least 20 g/100 g, more preferably at least 50 g/100 g, most preferably at least 100 g/100 g.

The solubility of the polymer in the solvent b) at 23° C. is preferably at most 10 g/100 g, more preferably at most 5 g/100 g, most preferably at most 1 g/100 g.

Ethylenically unsaturated monomers a) are, for example, ethylenically unsaturated C₃-C₆ carboxylic acids. These compounds are, for example, acrylic acid, methacrylic acid, ethacrylic acid, α-chloroacrylic acid, crotonic acid, maleic acid, maleic anhydride, itaconic acid, citraconic acid, mesaconic acid, glutaconic acid, aconitic acid, and fumaric acid, and also the alkali metal or ammonium salts of these acids.

Further polymerizable monomers a) are acrylamidopropanesulfonic acid, vinylphosphonic acid and/or alkali metal or ammonium salts of vinylsulfonic acid. The other acids may likewise be used in the polymerization either in non-neutralized form or in partially neutralized form.

Also useful are monoethylenically unsaturated sulfonic or phosphonic acids, for example allylsulfonic acid, sulfoethyl acrylate, sulfoethyl methacrylate, sulfopropyl acrylate, sulfopropyl methacrylate, 2-hydroxy-3-acryloyloxypropyisulfonic acid, 2-hydroxy-3-methacryloyloxypropylsulfonic acid, allylphosphonic acid, styrenesulfonic acid and 2-acrylamido-2-methylpropanesulfonic acid.

Further monomers a) are, for example, acrylamide, methacrylamide, crotonamide, acrylonitrile, methacrylonitrile, dimethylaminoethyl methacrylate, dimethylaminoethyl acrylate, dimethylaminopropyl acrylate, diethylaminopropyl acrylate, dimethylamino-butyl acrylate, dimethylaminoethyl methacrylate, diethylaminoethyl methacrylate, dimethylaminoneopentyl acrylate and dimethylaminoneopentyl methacrylate, and also their quaternization products, for example with methyl chloride, hydroxyethyl acrylate, hydroxyethyl methacrylate, hydroxypropyl acrylate and hydroxypropyl methacrylate.

Further monomers a) are monomers which are obtainable by reaction of nitrogen heterocycles and/or carboxamides, such as vinylimidazole, vinylpyrazole and vinylpyrrolidone, vinylcaprolactam and vinylformamide, with acetylene, which may also be quaternized, for example with methyl chloride, and monomers which are obtainable by reaction of nitrogen compounds, for example diallyldimethylammonium chloride, with allyl alcohol or allyl chloride.

The monomers a) used may also be vinyl and allyl esters and also vinyl and allyl ethers, such as vinyl acetate, allyl acetate, methyl vinyl ether and methyl allyl ether.

The monomers a) may be used alone or in a mixture with one another, for example mixtures comprising two, three, four or more monomers a).

Preferred monomers a) are acrylic acid, methacrylic acid and the alkali metal or ammonium salts of these acids, acrylamide, methacrylamide, acrylonitrile, methacrylonitrile, itaconic acid, vinylformamide, vinylpyrrolidone, vinylimidazole, quaternized vinylimidazole, vinyl acetate, sodium vinylsulfonate, vinylphosphonic acid, hydroxyethyl acrylate, hydroxyethyl methacrylate, 2-acrylamido-2-methylpropane-sulfonic acid, diallyldimethylammonium chloride and mixtures thereof.

Very particularly preferred monomers a) are acrylic acid, acrylate salts, vinyl-pyrrolidone, quaternized vinylimidazole, acrylamide, quaternized dimethylaminoethyl acrylate and/or diallyldimethylammonium chloride. Of the acrylate salts, preference is given to the alkali metal or ammonium salts, in particular sodium acrylate and potassium acrylate.

The concentration of the monomers a) in the monomer solution is typically from 2 to 80% by weight, preferably from 5 to 70% by weight, more preferably from 10 to 60% by weight.

When acid-bearing monomers a) are used, it is possible to adjust the solubility in the solvent b) to the desired value by means of the degree of neutralization and/or the counterion.

The monomers a) are preferably stabilized with a commercial polymerization inhibitor, more preferably with a polymerization inhibitor which acts only together with oxygen, for example hydroquinone monomethyl ether.

Commercial polymerization inhibitors are polymerization inhibitors which are used as storage stabilizers in the particular monomers for reasons of product safety. Examples of such storage stabilizers are hydroquinone, hydroquinone monomethyl ether, 2,5-di-tert-butylhydroquinone and 2,6-di-tert-butyl-4-methylphenol.

For optimal action, the preferred polymerization inhibitors require dissolved oxygen. Therefore, the polymerization inhibitors can be freed of dissolved oxygen before the polymerization by inertization, i.e. passing through an inert gas, preferably nitrogen. The oxygen content of the monomer solution is preferably lowered before the polymerization to less than 1 ppm by weight, more preferably to less than 0.5 ppm by weight.

The solvents b) used may be virtually any water-immiscible liquids which do not intervene in the polymerization, i.e. do not comprise any polymerizable groups. Water-immiscible means that the solubility of the solvent b) in water is less than 5 g/100 g, preferably less than 1 g/100 g, more preferably less than 0.5 g/100 g. For this purpose, preference is given to using aliphatic and aromatic hydrocarbons or mixtures of aliphatic and aromatic hydrocarbons. Suitable aliphatic hydrocarbons are, for example, pentane, hexane, heptane, octane, nonane, decane, cyclohexane, decalin, methylcyclohexane, isooctane and ethylcyclohexane. Aromatic hydrocarbons which can be used as the hydrophobic liquid are, for example, benzene, toluene and xylene. In addition, it will be appreciated that it is also possible to use other organic solvents such as ketones, esters, ethers and saturated alcohols. Preference is given to using toluene or hydrocarbons of a boiling range from 60 to 170° C.

By means of the selection of a hydrocarbon with a suitable boiling point as the solvent b), it is possible to decouple the polymerization/precipitation and the drying. A sufficiently high boiling point of the solvent b) prevents the drops from drying before polymerization and precipitation of the polymer have proceeded far enough.

The water content of the solvent b) is preferably less than 3% by weight, more preferably less than 0.5% by weight, most preferably less than 0.1% by weight.

The monomers a) are polymerized preferably in the presence of a crosslinker c) or of a combination of different crosslinkers. Crosslinkers are compounds having at least two polymerizable groups.

Suitable crosslinkers c) are, for example, (meth)acrylic esters of polyhydric alcohols which may be alkoxylated with up to 100, usually up to 50, ethylene oxide and/or propylene oxide units. Suitable polyhydric alcohols are in particular C₂-C₁₀ alkanepolyols having from 2 to 6 hydroxyl groups, such as ethylene glycol, glycerol, trimethylolpropane, pentaerythritol or sorbitol. Preferred crosslinkers are polyethylene glycol diacrylate and polyethylene glycol dimethacrylates, each of which derive from polyethylene glycols (which may be regarded as ethoxylated ethylene glycol) of molecular weight from 200 to 2000. Further useful crosslinkers c) are methylenebisacrylamide, trimethylolpropane triacrylate, trimethylolpropane trimethacrylate, ethylene glycol diacrylate, propylene glycol diacrylate, butanediol diacrylate, hexanediol diacrylate, hexanediol dimethacrylate or diacrylates and dimethacrylates of block copolymers of ethylene oxide and propylene oxide.

Also useful as crosslinkers c) are diallyl carbonate, allyl carbonates or allyl ethers of polyhydric alcohols which may be alkoxylated with up to 100, usually up to 50, ethylene oxide and/or propylene oxide units, and allyl esters of polybasic carboxylic acids.

Allyl carbonates of polyhydric alcohols correspond to the general formula I

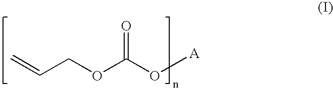

in which A is the radical of a polyhydric alcohol which may be alkoxylated with from 0 to 100, usually from 0 to 50, ethylene oxide and/or propylene oxide units, and n is the functionality of the alcohol, for example an integer from 2 to 10, preferably from 2 to 5. A particularly preferred example of such a compound is ethylene glycol di(allyl carbonate). Further suitable are particularly polyethylene glycol di(allyl carbonates) which derive from polyethylene glycols of molecular weight from 200 to 2000.

Preferred examples of allyl ethers include: polyethylene glycol diallyl ethers which derive from polyethylene glycols of molecular weight from 200 to 2000; pentaerythrityl triallyl ethers or trimethylolpropane diallyl ethers. Also suitable are reaction products of ethylene glycol diglycidyl ether or polyethylene glycol glycidyl ether with 2 mol of allyl alcohol and/or pentaerythrityl triallyl ether.

An example of a suitable allyl ester of a polybasic carboxylic acid is diallyl phthalate.

The monomers are preferably polymerized with one another in the presence of initiators d).

The initiators d) are used in customary amounts, for example in amounts of from 0.001 to 5% by weight, preferably from 0.01 to 1% by weight, based on the monomers to be polymerized.

The initiators d) used may be any compounds which decompose into free radicals under the polymerization conditions, for example peroxides, hydroperoxides, hydrogen peroxide, persulfates, azo compounds and the so-called redox initiators. Preference is given to the use of water-soluble initiators. In some cases, it is advantageous to use mixtures of different initiators, for example mixtures of hydrogen peroxide and sodium or potassium peroxodisulfate. Mixtures of hydrogen peroxide and sodium peroxodisulfate can be used in any ratio.

Suitable organic peroxides are, for example, acetylacetone peroxide, methyl ethyl ketone peroxide, tert-butyl hydroperoxide, cumene hydroperoxide, tert-amyl perpivalate, tert-butyl perpivalate, tert-butyl perneohexanoate, tert-butyl perisobutyrate, tert-butyl per-2-ethylhexanoate, tert-butyl perisononanoate, tert-butyl permaleate, tert-butyl perbenzoate, di(2-ethylhexyl) peroxydicarbonate, dicyclohexyl peroxydicarbonate, di(4-tert-butylcyclohexyl) peroxydicarbonate, dimyristyl peroxydicarbonate, diacetyl peroxydicarbonate, allyl perester, cumyl peroxyneodecanoate, tert-butyl per-3,5,5-trimethylhexanoate, acetylcyclohexylsulfonyl peroxide, dilauryl peroxide, dibenzoyl peroxide and tert-amyl perneodecanoate.

Preferred initiators d) are azo compounds, for example 2,2′-azobisisobutyronitrile, 2,2′-azobis(2,4-dimethylvaleronitrile) and 2,2′-azobis(4-methoxy-2,4-dimethyl-valeronitrile), in particular water-soluble azo initiators, for example 2,2′-azobis{2-[1-(2-hydroxyethyl)-2-imidazolin-2-yl]propane}dihydrochloride, 2,2′-azobis-(2-amidino-propane) dihydrochloride, 2,2′-azobis[2-(2-imidazolin-2-yl)propane]dihydrochloride and 2,2′-azobis[2-(5-methyl-2-imidazolin-2-yl)propane]dihydrochloride. Very particular preference is given to 2,2′-azobis[2-(2-imidazolin-2-yl)propane]dihydrochloride and 2,2′-azobis[2-(5-methyl-2-imidazolin-2-yl)propane]dihydrochloride.

Further preferred initiators are also redox initiators. The redox initiators comprise, as the oxidizing component, at least one of the above-specified peroxo compounds, and, as the reducing component, for example, ascorbic acid, glucose, sorbose, ammonium or alkali metal hydrogen sulfite, sulfite, thiosulfate, hyposulfite, pyrosulfite, sulfide or sodium hydroxymethylsulfoxylate. As the reducing component of the redox catalyst, preference is given to using ascorbic acid or sodium pyrosulfite. Based on the amount of monomers used in the polymerization, for example, from 1×10⁻⁵ to 1 mol % of the reducing component of the redox catalyst is used.

The polymerization is more preferably induced by the action of energy-rich radiation, in which case the initiators used are typically so-called photoinitiators. These may, for example be so-called α-cleavers, H-abstracting systems or else azides. Examples of such initiators are benzophenone derivatives such as Michier's ketone, phenanthrene derivatives, fluorene derivatives, anthraquinone derivatives, thioxanthone derivatives, coumarin derivatives, benzoin ethers and their derivatives, azo compounds such as the abovementioned free-radical formers, substituted hexaarylbisimidazoles or acylphosphine oxides, in particular 2-hydroxy-2-methylpropiophenone (Darocure® 1173). Examples of azides are 2-(N,N-dimethylamino)ethyl 4-azidocinnamate, 2-(N,N-dimethylamino)ethyl 4-azidonaphthyl ketone, 2-(N,N-dimethylamino)ethyl 4-azidobenzoate, 5-azido-1-naphthyl 2′-(N,N-dimethylamino)ethyl sulfone, N-(4-sulfonylazidophenyl )maleimide, N-acetyl-4-sulfonylazidoaniline, 4-sulfonylazidoaniline, 4-azidoaniline, 4-azidophenacyl bromide, p-azidobenzoic acid, 2,6-bis(p-azidobenzylidene)cyclohexanone and 2,6-bis(p-azidobenzylidene)-4-methyl-cyclohexanone.

Particularly preferred initiators d) are azo initiators such as 2,2′-azobis[2-(2-imidazolin-2-yl)propane]dihydrochloride and 2,2′-azobis[2-(5-methyl-2-imidazolin-2-yl)propane]dihydrochloride, and photoinitiators such as 2-hydroxy-2-methylpropiophenone and 1-[4-(2-hydroxyethoxy)phenyl]-2-hydroxy-2-methyl-1-propan-1-one, redox initiators such as sodium persulfate/hydroxymethylsulfinic acid, ammonium peroxo-disulfate/hydroxymethylsulfinic acid, hydrogen peroxide/hydroxymethylsulfinic acid, sodium persulfate/ascorbic acid, ammonium peroxodisulfate/ascorbic acid and hydrogen peroxide/ascorbic acid, photoinitiators such as 1-[4-(2-hydroxy-ethoxy)phenyl]-2-hydroxy-2-methyl-1-propan-1-one, and mixtures thereof.

The reaction is preferably carried out in apparatus which are also suitable for spray-drying. Such reactors are described, for example, in K. Masters, Spray Drying Handbook, 5th Edition, Longman, 1991, page 23 to 66.

The reaction temperature is preferably from 70 to 250° C., more preferably from 100 to 200° C., most preferably from 120 to 180° C.

In the process according to the invention, one or more spray nozzles may be used. The useable spray nozzles are subject to no restriction. The liquid to be sprayed can be fed under pressure to such nozzles. The liquid to be sprayed can be atomized in such a way that it is decompressed in the nozzle bore after it has attained a certain minimum speed. For the inventive purpose, it is also possible to use one-material nozzles, for example slot dies or swirl chambers (full-cone nozzles) (for example from Düsen-Schlick GmbH, Germany, or from Spraying Systems Deutschland GmbH, Germany).

Preference is given in accordance with the invention to full-cone nozzles. Among these, preference is given to those having an opening angle of the spray cone of from 60 to 180°. Particular preference is given to opening angles of from 90 to 120°. The mean droplet diameter which is established in the course of spraying is, in accordance with the invention, typically less than 1000 μm, preferably less than 200 μm, more preferably less than 100 μm, and typically greater than 10 μm, preferably greater than 20 μm, more preferably greater than 50 μm, and can be determined by customary methods such as light scattering, or on the basis of the characteristics obtainable from the nozzle manufacturers. The throughput per spray nozzle is appropriately from 0.1 to 10 m³/h, frequently from 0.5 to 5 m³/h.

The droplet diameter which is established in the course of spraying is appropriately from 10 to 1000 μm, preferably from 10 to 500 μm, more preferably from 10 to 150 μm, most preferably from 10 to 45 μm.

The reaction may also be carried out in apparatus in which the monomer solution can fall freely in the form of monodisperse droplets. Suitable apparatus for this purpose is as described, for example, in the patent U.S. Pat. No. 5,269,980, column 3, lines 25 to 32.

Dropletization by laminar jet disintegration, as described in Rev. Sci. Instr., Volume 38 (1966), pages 502 to 506, is likewise possible.

Preference is given to dropletization over spraying, especially when photoinitiators are used.

When, on the other hand, high throughputs of monomer solution are desired, preference is given to spraying the monomer solution into the reaction chamber.

The reaction may be carried out under elevated pressure or under reduced pressure; preference is given to a reduced pressure of up to 100 mbar below ambient pressure.

The reaction may be carried out in the presence of an inert carrier gas, inert meaning that the carrier gas cannot react with the constituents of the monomer solution. The inert carrier gas is preferably nitrogen. The oxygen content of the inert carrier gas is advantageously below 1% by volume, preferably below 0.5% by volume, more preferably below 0.1% by volume.

The inert carrier gas may be conducted through the reaction chamber in cocurrent or in countercurrent to the free-falling droplets of the monomer solution, preferably in cocurrent. The carrier gas, after one pass, is preferably recycled at least partly, preferably to an extent of at least 50%, more preferably to an extent of at least 75%, as cycle gas into the reaction chamber. Typically, a portion of the carrier gas is discharged after each pass, preferably at least 10%.

The gas flow rate is preferably adjusted in such a way that the flow in the reactor is directed, for example no convection currents opposed to the general direction of flow are present, and is, for example, from 0.02 to 1.5 m/s, preferably from 0.05 to 0.4 m/s.

The polymerization rate may be adjusted by the type and amount of initiator system used.

The polymerization rate can be controlled advantageously by the use of azo compounds or redox initiators as initiators. The startup behavior of the polymerization can be controlled better with azo compounds or redox initiators by means of selection of the initiator, initiator concentration and reaction temperature than, for example, with pure peroxide initiators.

Particularly advantageous are photoinitiators. When photoinitiators are used, the drying rate can be adjusted to the desired value via the temperature without the free radical formation being significantly influenced at the same time.

The carrier gas is appropriately preheated upstream of the reactor to the reaction temperature of from 70 to 250° C., preferably from 100 to 200° C., more preferably from 120 to 180° C.

The reaction offgas, i.e. the carrier gas leaving the reaction chamber, may, for example, be cooled in a heat exchanger. This condenses solvent b) and unconverted monomer a). Afterward, the reaction offgas can be at least partly reheated and recycled into the reactor as cycle gas. A portion of the reaction offgas can be discharged and replaced by fresh carrier gas, in which case solvent b) and unconverted monomers a) present in the reaction offgas can be removed and recycled.

Particular preference is given to an integrated heating system, i.e. a portion of the waste heat in the cooling of the offgas is used to heat the cycle gas.

The reactors can be trace-heated. The trace heating is adjusted in such a way that the wall temperature is at least 5° C. above the internal reactor temperature and condensation on the reactor walls is reliably prevented.

The reaction product can be withdrawn from the reactor in a customary manner, preferably at the bottom via a conveying screw, and if appropriate dried down to the desired residual moisture content and to the desired residual monomer content.

The process according to the invention combines, in an advantageous manner, the preparation and drying of a polymeric thickener in one process step, the heat of polymerization being usable at the same time for drying.

In the process according to the invention, it is possible to prepare polymeric thickeners which dissolve rapidly owing to their small particle size and the associated large surface area.

The polymeric thickeners preparable by the process according to the invention are suitable for thickening liquids, especially aqueous systems.

When aqueous solutions are treated with the thickeners obtainable by the process according to the invention, it is advantageous, especially in the case of thickeners based on acrylic acid as monomer a) to adjust the pH of the solution to be thickened to the desired value, for example 7, with a suitable base such as sodium hydroxide solution.

Even though the reaction time in the process according to the invention is drastically shortened compared to a precipitation polymerization customary to date, the process according to the invention affords polymer particles with comparable morphology. The polymerization is surprisingly sufficiently rapid that the sequence of polymerization, precipitation, drying is maintained and the desired small primary particles are obtained.

The primary particles obtained in one solvent droplet form, in the course of drying, agglomerates which have a raspberry-like morphology.

The polymeric thickeners obtainable by the process according to the invention are water-soluble; under some circumstances, slightly opaque, colloidal solutions can also be obtained. The thickened liquids prepared with the polymeric thickeners prepared by the process according to the invention do not comprise any particulate structures.

When, for example, water is thickened with a polymeric thickener prepared by the process according to the invention and the thickened solution is adjusted by addition of water to a viscosity of less than 100 mPas (measured according to DIN 51562), no detectable residue remains after filtration through a filter with a pore width of approx. 5 μm (for example by means of an S&S 589 Schwarzband filter paper from Schleicher & Schüll). The amount of residue can be determined by flushing with water, drying and reweighing.

The polymeric thickeners preparable with the process according to the invention can be used for aqueous systems, for example as an additive to papercoating slips, as a thickener for pigment printing pastes and as an additive to water-based paints such as masonry paints. They can also be used in cosmetics, for example in hair cosmetic preparations such as conditioners or hairsetting compositions, or as thickeners for cosmetic formulations, and for the surface treatment of leather.

The viscosity of 1% by weight aqueous solutions comprising polymers prepared by the process according to the invention at 23° C. is at least 5000 mPas, preferably at least 10000 mPas, more preferably at least 20000 mPas.

### EXAMPLES

### Example 1

1.5 kg of acrylic acid, 20 g of allyl methacrylate and 10 g of a 10% by weight solution of 2,2′-azo(2-methylbutyronitrile) in water were dissolved in 6.7 kg of toluene. This solution was spray-dispensed in a heated spray tower filled with nitrogen atmosphere (150° C., height 12 m, width 2 m, gas flow rate 0.1 m/s in cocurrent). The metering rate was 10 kg/h. At the bottom of the spray tower, a dry, white powder was obtained. The resulting powder was washed with toluene and dried. The morphology of the washed powder corresponded to that of the material which is obtained in a precipitation polymerization.

The resulting powder was dissolved in water and the pH of the solution was adjusted to 7 with sodium hydroxide solution.

The 0.5% by weight solution had a viscosity of 6000 mPas and the 1% by weight solution had a viscosity of 35 000 mpas.

### Example 2

1.5 kg of acrylic acid, 20 g of allyl methacrylate and 6 g of a 10% by weight solution of 2,2′-azo(2-methylbutyronitrile) in water were dissolved in 6.7 kg of toluene. This solution was spray-dispensed in a heated spray tower filled with nitrogen atmosphere (150° C., height 12 m, width 2 m, gas flow rate 0.1 m/s in cocurrent). The metering rate was 10 kg/h. At the bottom of the spray tower, a dry, white powder was obtained. The resulting powder was washed with toluene and dried. The morphology of the washed powder corresponded to that of the material which is obtained in a precipitation polymerization.

The resulting powder was dissolved in water and the pH of the solution was adjusted to 7 with sodium hydroxide solution.

The 0.5% by weight solution had a viscosity of 8000 mPas and the 1% by weight solution had a viscosity of 40000 mPas.

### Example 3

3.0 kg of acrylic acid, 40 g of allyl methacrylate and 12 g of a 10% by weight solution of 2,2′-azo(2-methylbutyronitrile) in water were dissolved in 6.7 kg of toluene. This solution was spray-dispensed in a heated spray tower filled with nitrogen atmosphere (150° C., height 12 m, width 2 m, gas flow rate 0.1 m/s in cocurrent). The metering rate was 10 kg/h. At the bottom of the spray tower, a dry, white powder was obtained. The resulting powder was washed with toluene and dried. The morphology of the washed powder corresponded to that of the material which is obtained in a precipitation polymerization.

The resulting powder was dissolved in water and the pH of the solution was adjusted to 7 with sodium hydroxide solution.

The 0.5% by weight solution had a viscosity of 7000 mPas and the 1% by weight solution had a viscosity of 35000 mPas.

### Example 4

3.0 kg of acrylic acid, 20 g of allyl methacrylate and 12 g of a 10% by weight solution of 2,2′-azo(2-methylbutyronitrile) in water were dissolved in 6.7 kg of toluene. This solution was spray-dispensed in a heated spray tower filled with nitrogen atmosphere (150° C., height 12 m, width 2 m, gas flow rate 0.1 m/s in cocurrent). The metering rate was 10 kg/h. At the bottom of the spray tower, a dry, white powder was obtained. The resulting powder was washed with toluene and dried. The morphology of the washed powder corresponded to that of the material which is obtained in a precipitation polymerization.

The resulting powder was dissolved in water and the pH of the solution was adjusted to 7 with sodium hydroxide solution.

The 0.5% by weight solution had a viscosity of 10000 mPas and the 1% by weight solution had a viscosity of 45000 mPas.

### Example 5

3.0 kg of acrylic acid, 20 g of allyl methacrylate and 12 g of a 10% by weight solution of 2,2′-azo(2-methylbutyronitrile) in water were dissolved in 6.7 kg of toluene. This solution was dropletized in a heated spray tower filled with nitrogen atmosphere (150° C., height 12 m, width 2 m, gas flow rate 0.1 m/s in cocurrent). The hole diameter in the dropletization was 150 μm. The metering rate was 8 kg/h. At the bottom of the spray tower, a dry, white powder was obtained. The resulting powder was washed with toluene and dried. The morphology of the washed powder corresponded to that of the material which is obtained in a precipitation polymerization.

The resulting powder was dissolved in water and the pH of the solution was adjusted to 7 with sodium hydroxide solution.

The 0.5% by weight solution had a viscosity of 13000 mPas and the 1% by weight solution had a viscosity of 50000 mpas.

1. A process for preparing a precipitation polymer by spray polymerization of a monomer solution comprising
a) at least one ethylenically unsaturated monomer,
b) at least one solvent,
c) optionally at least one crosslinker and
d) optionally at least one initiator, wherein the monomer a) is soluble in the solvent b), a polymer obtained by polymerization of the monomer a) is insoluble in the solvent b), and solubility of the solvent b) in water is less than 5 g/100 g.

2. The process according to claim 1, wherein the monomer a) is selected from the group consisting of acrylic acid, an acrylate salt, vinylpyrrolidone, quaternized vinylimidazole, acrylamide, quatemized dimethylaminoethyl acrylate, diallyldimethylammonium chloride, and mixtures thereof.

3. The process according to claim 2, wherein the solvent b) is toluene, cyclohexane, or a mixture thereof.

4. The process according to claim 1, wherein the solubility of the monomer a) in the solvent b) is at least 20 g/100 g.

5. The process according to claim 1 4, wherein the solubility of the polymer in the solvent b) is at most 10 g/100 g.

6. The process according to claim 1, wherein the reaction is carried out in the presence of an inert carrier gas.

7. The process according to claim 6, wherein the carrier gas, after one pass, is recycled at least partly into the reaction chamber.

8. The process according to claim 6, wherein the carrier gas is conducted in cocurrent through the reaction chamber.

9. The process according to claim 2, wherein the solubility of the monomer a) in the solvent b) is at least 20g/100 g.

10. The process according to claim 2, wherein the solubility of the polymer in the solvent b) is at least 10 g/100 g.

11. The process according to claim 7, wherein the carrier gas is conducted in cocurrent through the reactive chamber.
